(19) United States
(12) Patent Application Publication
(10) Pub. No.: US 2026/0222737 A1
(43) Pub. Date: Jul. 30, 2026

(54) SYSTEM FOR CREATING A SPATIAL SOUND EFFECT

(71) Applicant: Andrew Young Lok, Buffalo, NY (US)

(72) Inventor: Andrew Young Lok, Buffalo, NY (US)

(21) Appl. No.: 19/462,641

(22) Filed: Jan. 28, 2026

Related U.S. Application Data
(60) Provisional application No. 63/750,413, filed on Jan. 28, 2025.

(51) Int. Cl. H04R 5/02; H04R 1/02; H04R 1/40; H04R 5/04

(52) U.S. Cl. CPC H04R 5/02; H04R 1/026; H04R 1/028; H04R 1/403; H04R 5/04

(57) ABSTRACT

A system for creating a sound effect including a wheel with a speaker and an electronics package attached. The invention provides a spatial sound effect has two or more sound generating systems. Each sound system for producing sound has a first motor. A first support is operationally coupled to the first motor and extends in a first direction. The first motor rotates the first support about a first axis. A second support is operatively rotatably coupled to the first support and extends relative to the first support in a second direction not parallel to the first support. A second motor operatively coupled to the second support rotates the second support about the second direction.

### BACKGROUND OF THE INVENTION

The present invention is directed to a structure for producing sound, and more particularly, a structure for producing a spatial sound effect for a fully immersive and physically engaging audio experience.

This present invention is also a system designed as a distributed network of portable, rotating speaker modules. These speaker modules work together to create an immersive sound environment. Each speaker module is wirelessly synchronized through an audio server such as Snapcast, so that each speaker module may function as an independent sound source while remaining nearly perfectly aligned with other speakers in time. The system produces a layered sound field rich in motion, interference, and depth. The system may further be augmented with a central subwoofer and careful spatial placement for a unique experience.

Audio technology has reached unprecedented heights in terms of sound fidelity, convenience and accessibility. However, despite these advancements, the immersive potential of sound remains unexplored. Most existing sound systems rely on stationary speakers or simplistic panning techniques to create spatial effects. While effective, these prior art methods fail to fully harness the dynamic possibilities of sound movement and speaker movement in three dimensional space.

There is currently no system that combines dynamic speaker motion, real time sound spatialization and multi axis rotational control of speakers and sound to produce a fully immersive and physically engaging audio experience. Current prior art solutions such as stationary sound systems, such as the Leslie® speaker, which creates a Doppler like effect, are constrained by their static designs or single axis motion. They do not provide the versatility needed for creating a fully enveloping auditory experience that can match or exceed the dynamism of live performances, interactive installations, or experimental art.

This shortcoming becomes particularly acute as audiences increasingly seek sensory rich experiences in entertainment including not just music, but also as part of movies and videogames. Regardless of the domain, there is a growing unmet need for technologies that transcend traditional audio delivery; uniquely fill a three dimensional space, and engage users both physically and emotionally.

Accordingly, a structure which overcomes the shortcomings of the prior art is provided.

### SUMMARY OF THE INVENTION

A system for creating a spatial sound effect is provided. The system includes one o more sound generating systems. Each sound generating system has a first motor. A first support is operationally coupled to the first motor and extends in a first direction. The first motor rotates the first support about a first axis. A second support is operatively rotatably coupled to the first support and extends relative to the first support in a second direction not parallel to the first support. A second motor operatively coupled to the second support rotates the second support about the second direction. A speaker is mounted on the second support to rotate therewith.

In one embodiment of the invention a wheel is fixedly mounted to the second support. The speaker is mounted on a periphery of the wheel. A counterweight is mounted on the periphery of the wheel.

In another embodiment, the speaker communicates with a sound source by wireless communication.

In another embodiment, a second sound generating system emits sound, and a second sound generating system emits sound, simultaneously or alternatingly, or both, with the first sound generating system.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment. Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

### BRIEF DESCRIPTION OF THE DRAWINGS

The present disclosure will be better understood by reading the written description with reference to the accompanying drawing figure in which like reference numerals denote similar structure and refer to like elements throughout in which:

FIG. 1 is a schematic view of the sound system constructed in accordance with the invention;

FIG. 2 is a front elevation view of a single sound generating system for creating a spatial sound effect in accordance with the invention;

FIG. 3 is a flow chart for operating one or more respective sound generating systems within the system in accordance with the invention; and

FIG. 4 is a flow chart for performing the Execute Motor Function of FIG. 3 within the system in accordance with the invention.

FIG. 5 is a top plan view of an embodiment of the electronic component of the invention.

FIG. 6 is a side elevation view of an embodiment of the electronic component of the invention.

FIG. 7 is a schematic view of an embodiment of the electronic component of the invention.

FIG. 8 is a top plan view of an embodiment of the invention.

### DETAILED DESCRIPTION OF THE PREFERRED EMBODIMENTS

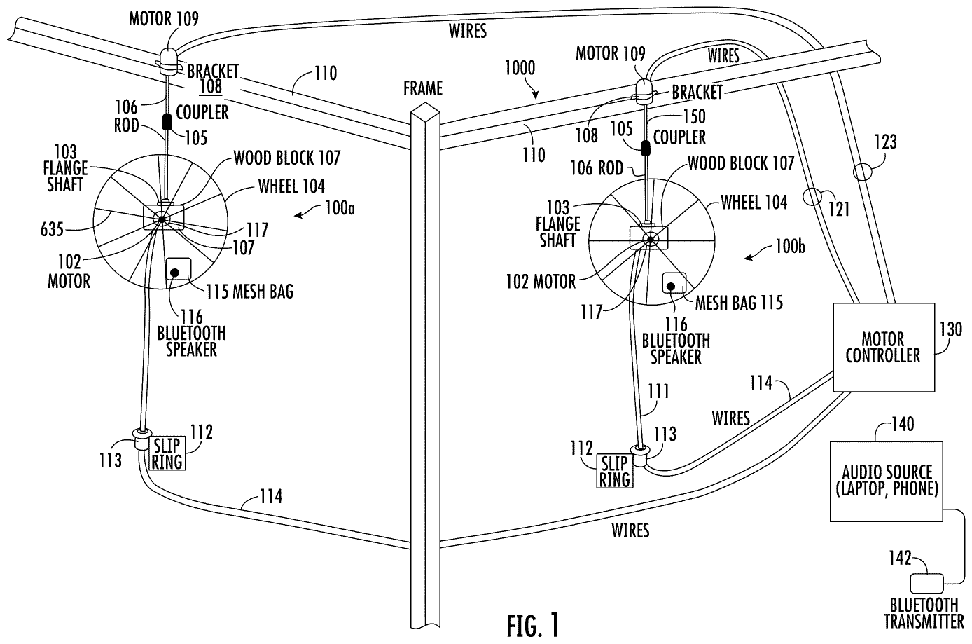

Reference is first made to FIG. 1 in which a system for creating spatial sound effects, generally indicated as 1000 is provided. System 1000 includes two or more sound generating systems 100a, 100b. Systems 100a, 100b are operated independently, but are synergistic in their effects. Alternatively, the operation of systems 100a and 100b may be coordinated with each other. Also, the sounds emitted from systems 100a and 100b may be coordinated.

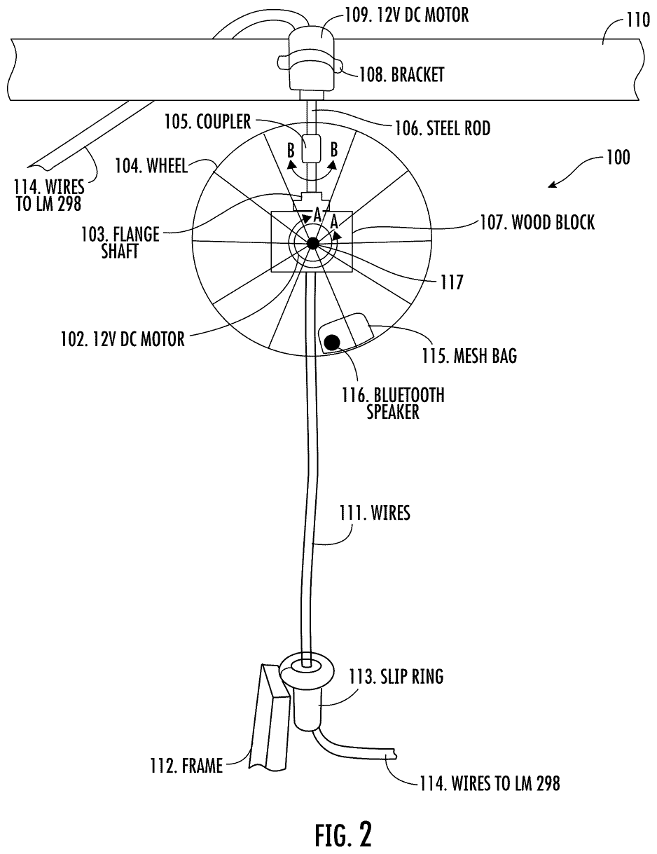

Reference is made to FIG. 2 in which a sound generating system 100a, emblematic of each sound generating system 100 and is described as emblematic of each sound generating system 100 in the system for creating sound effects 1000. System 100a includes a frame 110. A first motor 109 is fixedly mounted to frame 110. The first motor may be mounted by a bracket 108 or equivalent means to allow the motor to operate. In a preferred non limiting embodiment of motor 109, motor 109 is a bidirectional 12 volt DC motor.

A rod, or first support 106 is operatively coupled to, and rotated by, motor 109. In a preferred, non-limiting embodiment, to extend the length of rod 106, rod 106 may be formed as two shaft parts 150 connected by a coupler 105. A flange shaft 103 receives rod 106 therein and rotates therewith.

A platform, such as a block 107 is affixed to flange shaft 103. In one non-limiting embodiment, a second motor 102 is mounted on platform 107. Block 107 rotates with the associated flange shaft 103. A second support, or rod, 117, operatively coupled to a second motor 102, extends from block 107, preferably at an angle less than 180° relative to first support 106, in one preferred non limiting embodiment, so as not to be colinear or parallel therewith. In this way the second support 117 is operatively rotatably mounted to the first support 106 and second support 117 will rotate with first support 106 as first support 106 rotates. However, it is well understood that second support 117 and first support 106 operate independently of each other so that second support 117 rotates under the control of second motor 102 whether or not the first motor 109 operates and vice versa.

On the second platform, a wheel 104, in a preferred nonlimiting embodiment, is rotatably coupled to second support 117 and rotates therewith. A speaker 116 is disposed on wheel 104, at a position chosen as a function of the desired sound effect, but preferably, in a non-limiting embodiment at or near the periphery of wheel 104. In a preferred non limiting embodiment, speaker 116 is wireless and communicates with a sound generator through Bluetooth® protocol, microwave, other radio frequency communication technologies, or even optical communication by way of nonlimiting example.

In a preferred non limiting embodiment, support 106 is a steel rod, but may be formed of any material capable of operating under the strains experienced by support 106. First motor 109, in the preferred nonlimiting embodiment, is a multi-speed twelve volt bidirectional DC motor and is capable of rotating rod 106 in the directions of double headed arrow B-B. Motor 109 may be battery operated, or coupled to a non-battery power source. Motor 109 may be preferred to be a multi-speed motor and may also be operatively connected to a motor controller 130 such as a computer for controlling the speed, direction and duration at which motor 109 rotates rod 106. Block 107 rotates with rotation of rod 106.

In a preferred non limiting embodiment second support 117 is a steel rod, but may be formed of any material capable of operating under the strains experienced by second support 117. Second motor 102, in the preferred nonlimiting embodiment, is a multi-speed bidirectional twelve volt DC motor. Second motor 102 may be battery operated, or coupled to a non-battery power source. Second motor 102 may be preferred to be a multi-speed motor which may also be operatively connected to motor controller 130, such as a computer, in a preferred nonlimiting embodiment, for controlling the speed, direction and duration at which motor 102 rotates rod 117 in the direction of double headed arrow A-A.

In another preferred non limiting embodiment, a speaker 116 is affixed to platform 104. Attachment is preferred to be on the platform 104 such as the wheel shown in FIG. 1. The attachment may be through a resealable mesh bag 115 to provide access to the speaker 116; for repair or to change sound effect. A counterweight may be disposed on platform 104 to facilitate smooth rotation of platform 104. One speaker 116 is shown for ease of description, however it is well within the scope of the invention that more than one speaker may be disposed about platform 104 as a function of desired sound effect. In another embodiment, one or more counterweights may include a package of electronics for control of the speaker or the motor, or both. In addition, lights may be disposed on the platform.

Each speaker 116 is operatively connected to an audio source 140. Audio source 140 outputs sound signals to a transmitter such as a Bluetooth®transmitter 142 in communication with a respective one or all speakers 116 which may also be Bluetooth® enabled. In a preferred non limiting embodiment a speaker 140 is addressable so that signals can be individually sent to a specific Bluetooth® enabled speaker 116, all of Bluetooth® enabled speakers 116 or a subset thereof. Audio source 140 may be a smart phone, laptop, tablet or the like.

During use, when first motor 109 is activated, motor 109 rotates support rod 106 in either direction of double headed arrow A-A. Control and powering of motor 109 is hardwired in an exemplary, non-limiting, embodiment. Otherwise, the wires would begin to twist on themselves causing wear and tear and eventual malfunctions as rod 106 rotates during use. Here first wires 111 are connected to motor 102 to provide energy and instructions thereto. Second wires 114 electrically coupled to first wires 111 are operatively coupled to a motor controller 130. As can be seen in FIG. 1, in a preferred non limiting embodiment motor controller 130 controls the operation of two or more motors 109.

To prevent tangling and maintain electrical conductivity, a frame 112 is provided. An electronically conductive slip ring 113, affixed to frame 112 to prevent rotation thereof, electronically couples wires 111 to wires 114. Slip ring 113 enables wires 111 to rotate, with rotation of motor 102, relative to wires 114 without losing conductivity; enabling signals to pass unimpeded. Alternatively motor controller 130 may be wirelessly coupled to motors 102, 109 by radio frequency, or any other electromagnetic communication signal. Again, the motors 102, 109 are individually addressable, even in the hardwired embodiment.

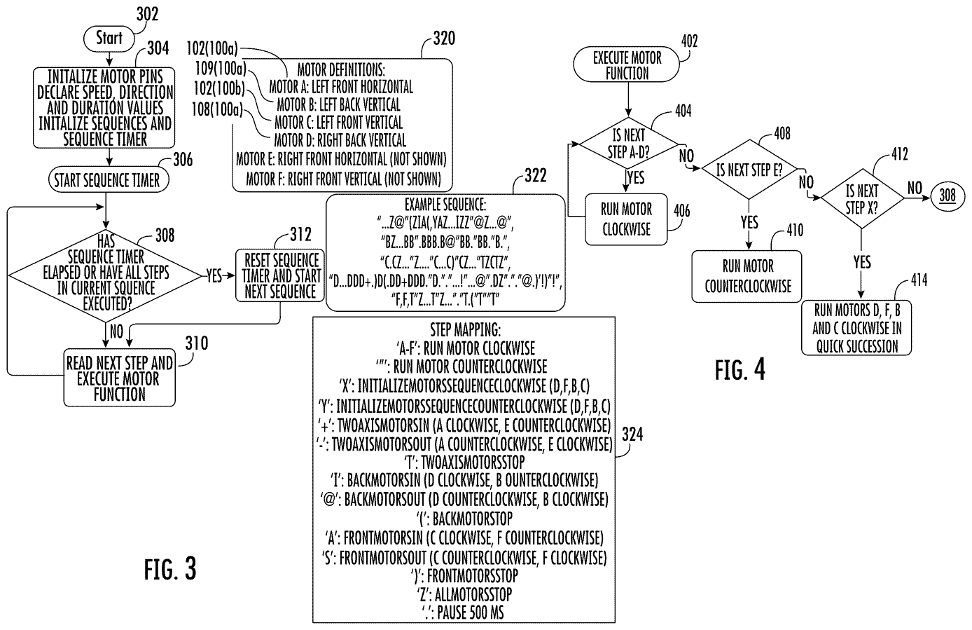

Reference is now made to FIG. 3 in which the operation of motors 102, 109 in accordance with the invention is shown. In a step 302 the process begins, and system 100a, 100b . . . 100n are initialized by setting the times and/or sequence of operation of respective motors 102, 109 for each system 100. Accordingly, in a step 304 the operational sequence, including control parameters motor speed, direction, timing and duration, as well as sequence of operation between motors 102, 109, and among systems 100a, 100b . . . 100n are set in motor controller 130.

Once set, the sequence timer is started in a step 306 it is then determined whether the current sequence is completed in a step 308. Motor controller 130 determines whether the timer set in step 304 has elapsed, or whether each of sequences have been completed. If the timer has not elapsed and the sequence has not been completed, then in a step 310 the next sequence step is performed, and the process is returned to step 308. If the timer has elapsed or the sequence has been completed, then in a step 312 the sequence timer is reset, the next sequence is started, and the process moves to step 310.

In a simplified embodiment of the invention the commands, or steps, addressed to specific motors may be, in one non limiting embodiment, as follows, as is shown in FIG. 3. Four motors are defined at 320, an exemplar of a sequence is provided at 324, and a sample step mapping for the motors Is provided at 324. The motors in this example are defined as follows:
A: Motor 102(100a) left vertical
B: Motor 109(100a) left horizontal
C: Motor 102(100b) right vertical
D: Motor 109(100b) Right Horizontal

In Step 310 system 1000 operates in response to these commands/steps.

Reference is now made to FIG. 4 wherein the operation of the system in step 310 is provided with greater particularity. In a step 402 the execution of a motor function to produce a single sound effect begins. In a step 404, it is determined whether the next step to be performed is any one of A-D. If A, by way of nonlimiting example, then motor 102(100a) will be rotated counterclockwise. The process returns to step 404 until it is determined that all of steps A-D of a given sequence in step 404 have been performed. If a next step to be performed is not A-D, then the process moves on to the next step, here step 408, where it is determined whether the next step is step E. If so, then in a non-limiting embodiment, an addressed motor is run counterclockwise in a step 410. If the next step is not the E command, then it is determined in a step 412 whether the next command is X. If the next command is X, then motors 102, 109, by way of non-limiting example, are run clockwise in unison in a step 414. If the next step is not X, the process returns to step 308.

At the same time as the rotation of the system is occurring, audio source 140 is providing audio signals, for example by Bluetooth® communication. The audio signals are also preprogrammed or may be entered in real time, by a performer providing inputs at audio source 140.

Multiple systems 100 may be used to enhance the sound effect. Audio files may be played from a source such as a laptop, tablet, or smart phone, in communication with one or more speakers 116. The structure and operation enable the audio to be wirelessly transmitted to speakers 116 mounted on the motorized platforms 104, seamlessly integrated with the mechanical components to produce the desired auditory effects.

In a preferred non limiting embodiment each of motors 102, 109 is controlled by a respective motor driver; an L298 motor driver module in a preferred non limiting embodiment. The motor drivers control the motors handling power delivery, speed regulation, and directional control. These drivers enable smooth independent operation of each motor 102, 109 across system 1000. Their modular arrangement supports synchronized and independent arrangement operations for diverse movement patterns. All are under control of motor controller 130, which in a preferred nonlimiting embodiment is a microcontroller such as an Arduino Mega controller.

On an individual level, each motor 102, 109 is capable of operating at different speeds and in different directions (clockwise and counterclockwise) controlled by the L298 motor driver module. Motor controller 130 controls timed operations utilizing a motor duration array which specifies respective motor movement times, ensuring synchronized and accurate motor actions.

As discussed above, motor controller 130 executes predefined movement sequences; each sequence being divided into timed steps with specific defined actions for each motor 102, 109. Single character demands such as A, D, X, may dictate motor operation for individual or grouped motors 102, 109. Sequences are performed step by step with timed intervals between execution. As shown above once a sequence is completed the system may either reset or transition to another sequence.

By using a comprehensive set of motor control commands enables granular control of motor operation. Use may be made of initialization commands such as clockwise and counterclockwise for motor group actions. Directional commands may also be used, as well as global commands, such as complete motor stop ensure safe operation.

Each speaker 116 in each system 100 can be independent of another speaker 116. Each speaker 116 is capable of receiving separate, addressed, audio signals from audio source 140. As a result, system 1000 enables dynamic control of individual audio streams with an ability to adjust volume and equalization. Individual volume levels are configured and updated in real time. As a result of the equalization capability, dynamic equalization settings for each speaker 116 is enabled supporting fine tuning of bass, treble and midrange frequencies as a function of operational requirements or user preferences. As a result, system 1000 allows for precise audio synchronization with motor movement, creating the immersive and interactive experience. Speakers and systems may also be paired and grouped to act in coordination.

In one embodiment, audio input may be from any source, including but not limited to locally saved files, live microphones, and music app streams (e.g., Spotify, Pandora). The computer such as a Raspberry Pi encodes the audio using PCM format (to maximize audio fidelity) and distributes it over Wi-Fi.

As can be seen from the above, each speaker system 100 can receive a unique audio feed, enabling diverse soundscapes or audio coordination for multichannel output. The system independently adjusts volume levels for each speaker in real time, ensuring flexibility and synchronization with motor operation. The system independently adjusts equalization for each speaker tailoring the sound profile to compliment the motor movements or ambient environment. As a result, the speaker adds a dynamic audio component.

As a result of the above system, a system for improved sound manipulation is provided. The above structure and modular motor logic provides a scalable platform. The independent control of motors and speakers makes this system highly versatile enabling expansion to additional motors and/or speakers, and greater synchronization between audio and motor actions. It enables dynamic sound experience by controlling the movement and position of the speakers, creating unique auditory effects.

By providing a multi motor rotational speaker system capable of synchronizing movement with music in novel ways. By dynamically altering the orientation of each speaker, the system creates a three dimensional soundscape that not only transforms the listener's perception of sound but also enhances emotional engagement and spatial immersion. The present invention enables new possibilities for audio experiences that are more captivating, interactive, and transformative than ever before.

In yet another embodiment of the invention, a system is provided which is a distributed network of portable, rotating speaker modules that work together to create an immersive sound environment. Each unit is wirelessly synchronized through a client server audio player such as Snapcast, allowing the speaker modules to function as independent sound sources while remaining aligned in time. In another embodiment, the small, mobile speakers of the system may be combined with a central subwoofer and careful spatial placement to produce a novel layered sound field rich in motion, interference, and depth. For example, a laptop can function as one of the Snapclients, but rather than driving a small speaker, it is connected to a subwoofer soundbar. This allows the laptop to anchor the low-frequency content physically closer to the two front units, reinforcing bass presence in the system.

In one example, there are four Raspberry Pi Zero Snapclients serving as the main distributed speaker nodes:
Front Left/Right speakers: mounted on two-axis rotating rigs without enclosures. Their sound is complemented by the subwoofer positioned nearby, giving these unboxed drivers additional low-end support.
Back Left/Right speakers: built into enclosures fitted with passive radiators. This provides more contained bass extension and projection, balancing the open character of the front units.

In this configuration, Pi Zero nodes buffer incoming audio and use network timestamps for sample-accurate synchronization. The result is that every speaker—including the subwoofer on the laptop client—remains in lockstep, with no drift or phasing across the space.

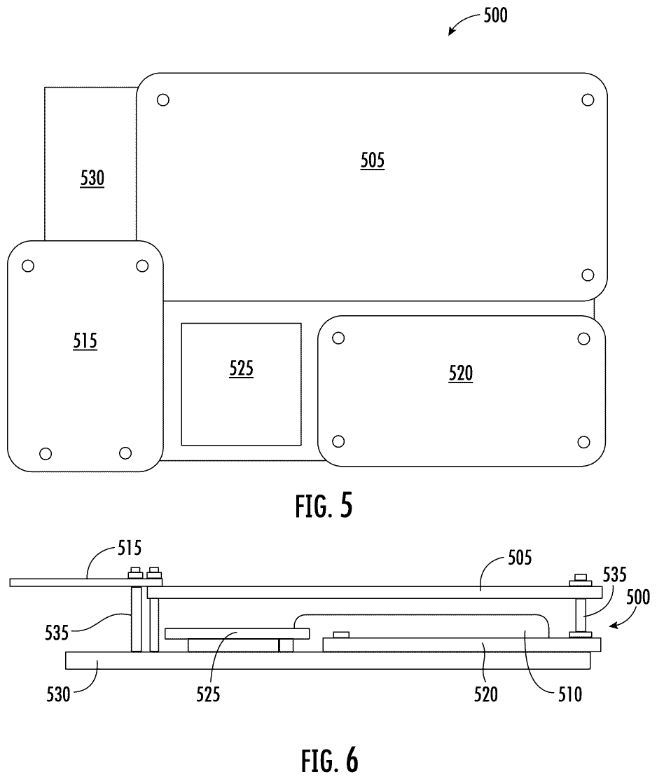

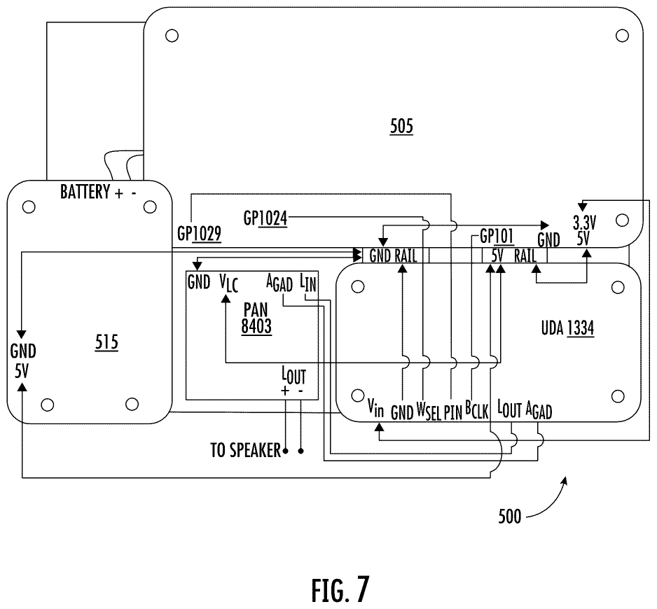

A speaker electronics module 500 may be built as shown in FIGS. 5-7. The module 500 may use a computer 505 incorporating wireless and/or Bluetooth(r) technology, such as a Raspberry Pi Zero running Snapclient, which acts as a lightweight networked audio client. Power for the speaker module may be provided by a battery 510 such as a 3.7 V LiPo battery which may be in connection with a boost converter 515 such as an Adafruit PowerBoost 1000C, to provide a regulated 5 V output. the Pi Zero, PowerBoost, and one or more DAC boards 520 such as a UDA1334a and one or more amplifier boards such as a PAM 8403 525 all may be mounted on a shared piece of perfboard 530 as is known in the art to keep the speaker module 500 compact and mechanically stable. Boards may be stacked and spacers 535 may be used between the boards 530. Spacers 535 provide gaps for airflow and prevent electrical shorts while keeping the whole speaker module 500 rigid. The result is a flat, layered assembly for the speaker module 500 that is lightweight, easy to handle, and takes up minimal space inside a provided speaker housing. Arrangement of the boards as shown in FIGS. 5 and 6 allow wiring between modules stays short and clean, thereby reducing both signal noise and the chance of loose connections. This compact form also allows the module 500 to be attached to a wheel of the invention without adding unwanted and unnecessary bulk. One schematic drawing of one embodiment of the invention showing the electrical connections for the elements of the speaker module 500 is illustrated in FIG. 7 and described below:

The PowerBoost 1000C is powered by a 3.7 LiPo battery. It outputs 5V to a rail which supplies power to the following:
Pi Zero (5V pin)
PAM8403 Amplifier (vcc)

The DAC board UDA1334 (Vin) is powered separately by 3.3V output pin from Pi Zero.

A common ground rail ties together the grounds on the following: Pi Zero, PAM8403 and UDA1334.

The Audio Signal Path is illustrated is as follows:
Pi Zero (I²S output) to UDA1334 DAC
GPIO29 (PCM_DOUT) to DIN (audio data)
GPIO1 (PCM_CLK) to BCLK (bit clock)
GPIO24 (PCM_FS) to WSEL (frame sync/word select)
UDA1334 DAC to PAM8403 amplifier
Lout to Lin
Agnd to Agnd (audio ground)

In the schematic diagram of FIG. 7:
PCM_DOUT/DIN carries the audio bits.
PCM_CLK/BCLK (bit clock) ticks out each bit of the audio data.
PCM_FS/WSEL (frame sync/word select) runs at the sample rate (e.g. 48 kHz) and marks the boundary between left and right channel samples.
Even though the DAC outputs both channels, in this design only the left channel (Lout+/−) is connected to the amplifier and speaker, the right channel (Rout) is unused.

In one embodiment, for Speaker Output:

From the PAM8403 amplifier, only the left channel is used:
PAM8403 Lout+/− to single speaker, such as a 2″ speaker.

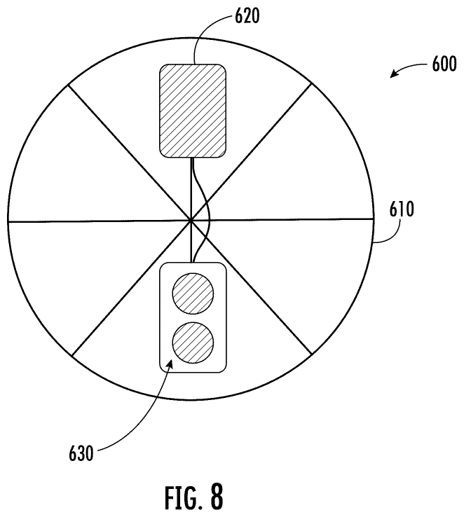

A non-limiting embodiment of the invention is illustrated in FIG. 8, showing a sound generation module 600. This module includes a wheel 610. An electronics module 620 and a speaker 630 in electronic connection with the electronics module 620 are rigidly attached to the wheel 610. One or more electronics modules 620 may work as a counterweight to one or more speakers 630 when the wheel turns. The electronics module 620 may be physically wired to the speaker 630 as show, or they may be in electronic communication wirelessly. The wheel may include an axle 635 to facilitate turning by a motor.

Lights and scents and other effects may also be attached to the wheel and controlled by the electronics package.

It will thus be seen that the objects set forth above, among those made apparent from the preceding description, are efficiently attained and, since certain changes may be made in carrying out the above method and in the construction set forth without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

1. A system for creating a spatial audio effect comprising two or more sound generating systems, each sound generating system comprising:
a first motor;
a first support operatively coupled to the first motor and extending in a first direction, the first motor rotating the first support about a first axis;
a second support operatively rotatably coupled to the first support and extending relative to the first support in a second direction not parallel to the first support;
a second motor operatively coupled to the second support rotates the second support about the second direction; and
a speaker mounted on the second support to rotate therewith.

2. The system of claim 1, further comprising
an audio source operatively coupled to each speaker; and
a motor controller for controlling the first motor and second motor of each respective sound generating system.

3. A sound generating device for creating a spatial audio effect, comprising:
a rotatable wheel;
one or more speakers attached to an outer portion of the wheel; and
one or more electronics modules in electronic communication with the speaker attached to an outer portion of the wheel generally opposite from the speaker;
wherein the electronic package is a counterweight to the speaker attached to the wheel.

4. The device of claim 3, wherein the electronics module comprises:
a computer;
a battery;
a boost converter in connection with the battery;
one or more digital to analog converters in connection with the battery; and
one or more amplifier boards in connection with the digital to analog converters and the battery.

5. A sound effect system, comprising:
a plurality of sound generating devices, including,
a rotatable wheel;
one or more speakers attached to an outer portion of the wheel; and
one or more electronics modules in electronic communication with the speaker attached to an outer portion of the wheel generally opposite from the speaker;
wherein the electronic package is a counterweight to the speaker attached to the wheel.

6. The sound effect system of claim 5, further comprising:
a second computer in electronic communication with the electronic modules and in coordinated electronic communication with a soundbar.

7. The sound effect system of claim 5, wherein the electronics module is able to receive audio input from at least one source from the group of locally saved files, live microphones and music app streams.
